(19) United States
(12) Patent Application Publication
(10) Pub. No.: US 2010/0157053 A1
(43) Pub. Date: Jun. 24, 2010

(54) Autonomous Recall Device

(75) Inventor: John Helmes, Cambridge (GB)

Correspondence Address: LEE & HAYES, PLLC, 601 W. RIVERSIDE AVENUE, SUITE 1400, SPOKANE, WA, 99201, US

(73) Assignee: Microsoft Corporation, Redmond, WA (US)

(21) Appl. No.: 12/343,004

(22) Filed: Dec. 23, 2008

(51) Int. Cl. H04N 7/18; G06F 3/00

(52) U.S. Cl. 348/143; 715/810; 348/E07.085

(57) ABSTRACT

An autonomous recall device is described. A camera is movably mounted in a housing so that the camera, in some embodiments, may automatically pan and tilt. One or more environmental sensors are incorporated, such as microphones in some embodiments. In other embodiments sensors are provided physically separate from the recall device but in communication with the recall device. At least one processor in the device controls the movement and actuation of the camera according to conditions monitored by the sensor(s). Also an attention device is provided in the recall device and is controlled by the microprocessor. In an embodiment the attention device comprises light emitting diodes, actuation of the pan and tilt mechanisms, and optionally opening and closing of a cover concealing the camera. The recall device may be perceived as having its own “character”. Captured content may be retrieved via a web service in some embodiments.

### BACKGROUND

There is a desire to provide a recall device which enables people to re-experience spontaneous moments from the past. Previously, image capture devices such as digital cameras, video cameras and the like have been used to capture images to assist people with recalling events. However, these devices typically require manual operation to capture an image and require a person to remove him or herself from a conversation or social interaction in order to operate the image capture device. Use of an image capture device by a person is intrusive in social settings and alters the dynamics of the social interaction so that the resulting captured images may not be a good representation of the moment. In addition, operation of the image capture device is a skilled task which cannot always be undertaken by users who are very young, have disabilities, or are infirm.

Where manual operation of image capture devices is used, the resulting images are predictable in the sense that the user of the capture device is able to recall when he or she operated the device. It is difficult for the manually operated device to be used to capture images of spontaneous moments because often that moment has passed before the image capture device may be operated. Also, the person using the image capture device is unable to participate fully in any social interaction taking place and so loses that valuable moment. For example, a mother at a young child's birthday meal may find that in order to take photographs of the event she misses out on participating in the event and loses the joy of being in those valuable moments.

Image capture devices may also provoke anxiety in the subject, for example, a person being photographed or filmed typically realizes this and experiences anxiety and typically “poses for the camera”.

Recall devices which may be worn by a person are known for assisting memory impaired users with recall of events. These devices may capture images automatically according to sensed environmental conditions. However, such devices are configured to be worn and are not suitable for capturing spontaneous moments during social interactions between groups of people in domestic environments such as family meals, coffee mornings, a graduation party, group discussions and the like.

Image capture devices which may be thrown are also known. This type of device may also capture images according to sensed sound or movement cues. Such devices are not suitable for capturing spontaneous moments during social interactions between groups of people.

The embodiments described below are not limited to implementations which solve any or all of the disadvantages of known recall devices.

### SUMMARY

The following presents a simplified summary of the disclosure in order to provide a basic understanding to the reader. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

An autonomous recall device is described. In an embodiment, the recall device is configured to stand on a surface such as a coffee table or kitchen worktop. A camera is movably mounted in a housing so that the camera, in some embodiments, may automatically pan and tilt. One or more environmental sensors are incorporated in the device, such as microphones in some embodiments. In other embodiments sensors are also provided embedded in the environment, physically separate from the recall device but in communication with the recall device. At least one processor in the device controls the movement and actuation of the camera according to conditions monitored by the sensor(s). Also an attention device is provided in the recall device and is controlled by the processor. In an embodiment the attention device comprises light emitting diodes, actuation of the pan and tilt mechanisms, and optionally opening and closing of a cover concealing the camera. The recall device may be perceived by humans as having its own “character” and “presence”. Captured content may be retrieved via a web service in some embodiments.

Many of the attendant features will be more readily appreciated as the same becomes better understood by reference to the following detailed description considered in connection with the accompanying drawings.

### DESCRIPTION OF THE DRAWINGS

The present description will be better understood from the following detailed description read in light of the accompanying drawings, wherein:

FIG. 1 is a side view of a recall device in closed configuration;

FIG. 2 is a perspective view of the recall device of FIG. 1;

FIG. 3 is an exploded view of the recall device of FIG. 1;

FIG. 4 is another exploded view of a recall device;

FIG. 5 shows the underside of the cover of the recall device of FIG. 1;

FIG. 6 is a schematic diagram of electronic components of a recall device;

FIG. 7 is a schematic diagram of another example of electronic components of a recall device;

FIG. 8 is a schematic diagram of an environment in which a recall device is used;

FIG. 9 is a flow diagram of a method at a recall device;

FIG. 10 is a flow diagram of a capture process at a recall device;

FIG. 11 is a flow diagram of an attention process at a recall device;

FIG. 12 is a schematic diagram of a web service;

FIG. 13 is a flow diagram of a method at a web service;

FIG. 14 is an exploded view of another embodiment of a recall device;

FIG. 15 is a perspective view of the recall device of FIG. 14;

FIG. 16 illustrates a computing-based device in which embodiments of a recall device and/or web service may be implemented.

Like reference numerals are used to designate like parts in the accompanying drawings.

### DETAILED DESCRIPTION

The detailed description provided below in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples.

Although the present examples are described and illustrated herein as being implemented in a recall device using sound sensors, the system described is provided as an example and not a limitation. As those skilled in the art will appreciate, the present examples are suitable for application in a variety of different types of recall devices using any suitable environmental sensors.

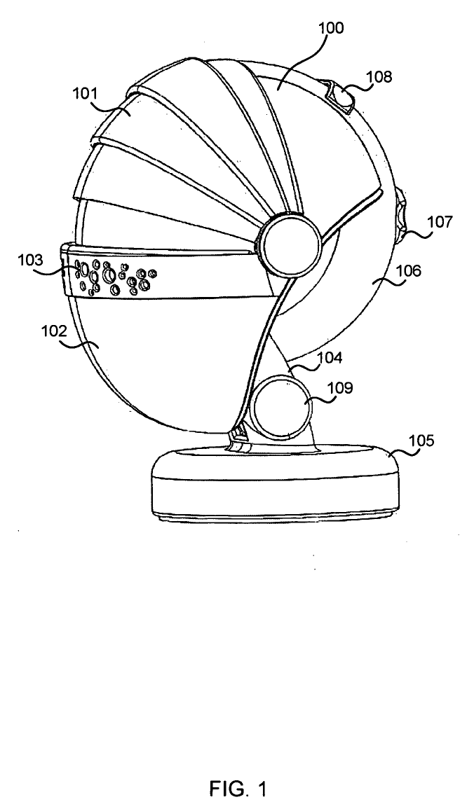

FIG. 1 is a side view of a recall device which is configured to stand on a domestic or other surface such as a coffee table, desk, kitchen worktop or other surface. The recall device is autonomous in that it may operate alone without the requirement for user input. The recall device is portable. For example, it may be of a similar size and weight to a large coffee mug although it may be of any size and weight suitable for portability.

The recall device is arranged to capture any combination of audio, video and still images and optionally also sensor data. This captured content is then used to assist in recall of moments from the past by review or display of that content in any suitable manner. For example, this may be by using a web service as described later, by using dedicated display devices such as digital photo frames, or by using any other suitable content retrieval and display equipment.

The recall device is able to move, for example, by panning and tilting or in any other suitable manner. It incorporates attention devices which are operable to attract the attention of people or other entities in physical proximity to the device. It is programmed to behave autonomously such that it projects its own “presence” into a social environment and appears to have its own “character”.

FIG. 1 shows the housing of the recall device in a closed configuration. In an open configuration the housing reveals a camera as described in more detail below. The housing comprises a shell 100 having a retractable cover 101 a fixed lower cover 102 and a microphone guard 103 which is optionally also fixed. In some embodiments the microphone guard is movable and microphones are movably mounted in the device such that they are able to move independently of the main shell. This enables more information to be sensed about how far the device is to rotate (as described below). The shell is made of any suitable lightweight, protective, translucent material such as plastics. The microphone guard comprises apertures to enable sound to reach microphones located behind that guard. The shell is supported on a stand 104 which is attached to a base 105 configured to rest on a surface. The stand 104 is movably connected to the base 105 using a joint 109 which enables the housing to tilt up and down. The base has anti-slip pads to prevent the recall device from sliding about.

The shell is also supported using an arm 106 which extends from the stand 104 to the retractable cover 101. Within the arm is a potentiometer which provides input to a microprocessor for a slider control 108 that sets sensitivity level of the microphones. A servo motor located next to the camera is used for opening and closing the retractable cover 101 as described below. As mentioned, sensitivity level slider control 108 is provided on the arm together with a functionality selection wheel 107. The functionality selection wheel may be used to select between different capture options such as “video and audio capture”, “still image capture without audio capture”, “still image capture with audio”, and “audio alone”.

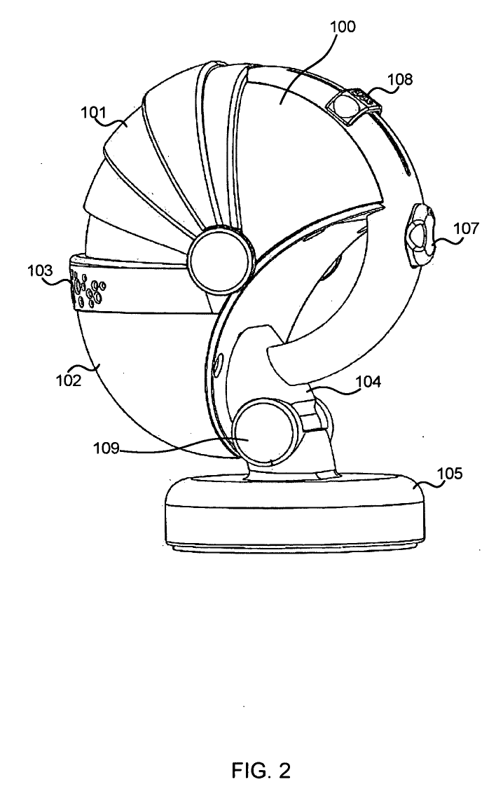

FIG. 2 is a perspective view of the recall device of FIG. 1 from which the stand 104 can be seen in more detail.

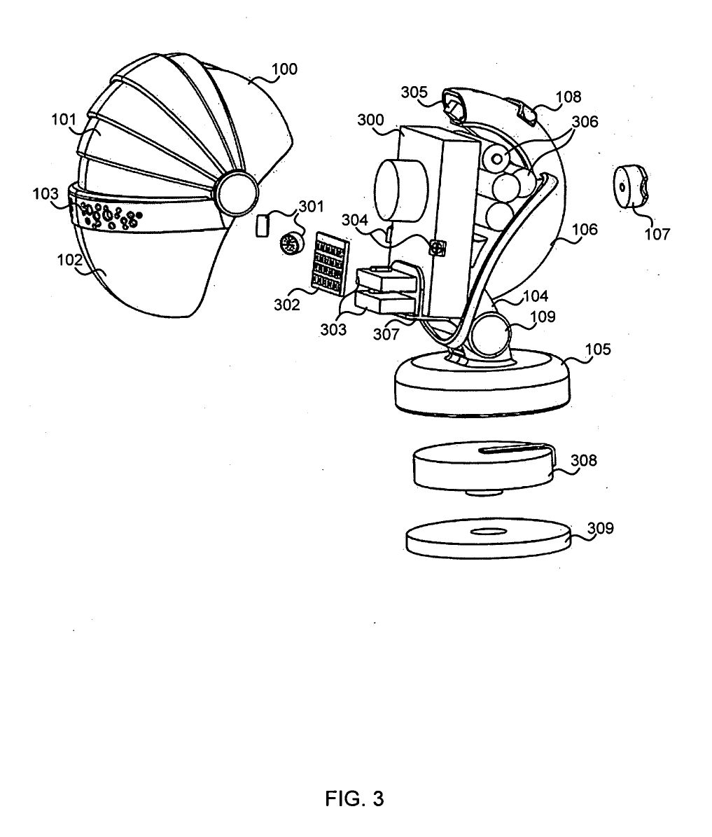

FIG. 3 is an exploded view of the recall device of FIG. 1. Incorporated in the base 105 is a stepping or rotation motor 308 which is used to rotate the device by as much as 360 degrees about a longitudinal axis of the device. A plate 309 is used to hold the stepping motor 308 in the base 105. As mentioned above, the arm 106 is hollow and incorporates a potentiometer 305 for the slider control 108. A support structure 307 is provided attached to the stand 104 and arm 106. This support structure holds batteries 306, a camera 300 and microprocessors 303. The camera is a digital camera of any suitable type which is able to capture video clips with audio, still images with audio, or still images without audio.

Attached to the camera are colored light emitting diodes (RGB LEDs) 304. These RGB LEDs may be angled towards one another slightly in order that light they produce shines across a large area of the front of the shell 100, cover 101 and guard 103.

The microprocessors are of any suitable type and in this example, two microprocessors are shown. However, it is also possible to use one microprocessor or any other suitable number of microprocessors depending on space and processing requirements.

Also provided are two microphones 301 which are to be supported on the shell behind the guard 103 and laterally spaced apart by a suitable distance. If the microphones are too far apart a “dead zone” is experienced between the two microphones in which little sound is detected. If the microphones are too close together interference between them becomes too great. Also provided is a matrix or an array of LEDs 302 which may be attached to the inner side of the cover 102.

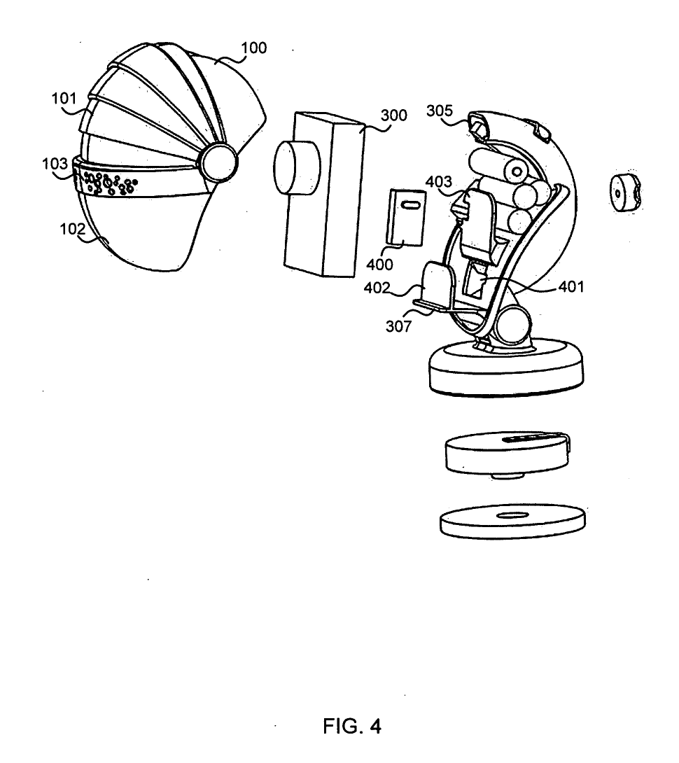

FIG. 4 is another exploded view of a recall device. The camera 300 is exploded away from the support structure 307 which has flanges 402, 403 configured to hold the camera. Aperture 401 is revealed which extends from the support structure 307 into the stand. This aperture is configured to hold a servo motor for controlling the tilt of the housing about joint 109. Also shown is a microprocessor positioned on the side of the camera thus illustrating how components within the device may be arranged differently in different embodiments.

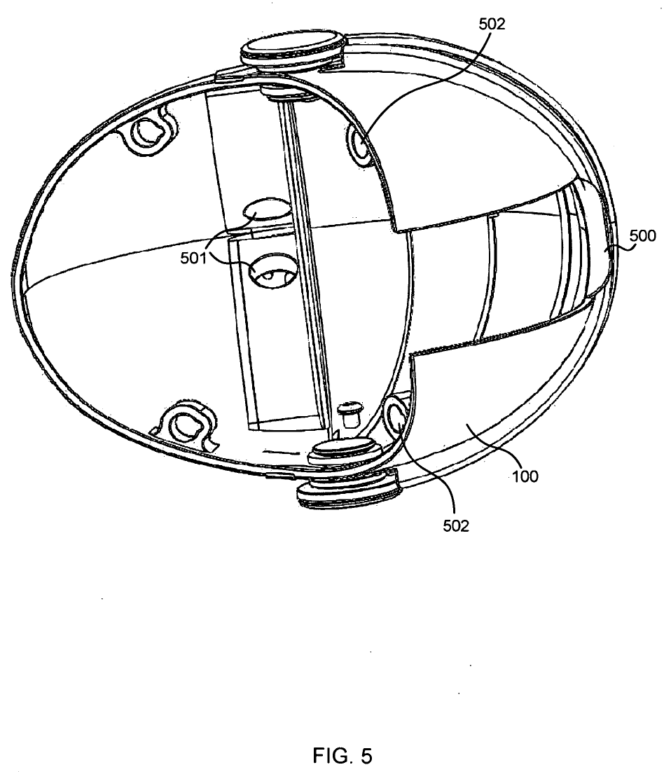

FIG. 5 is a view of the underside of the shell 100 showing chambers 501 for holding the microphones. Part 500 is also visible which connects to the end of arm 106, FIG. 3.

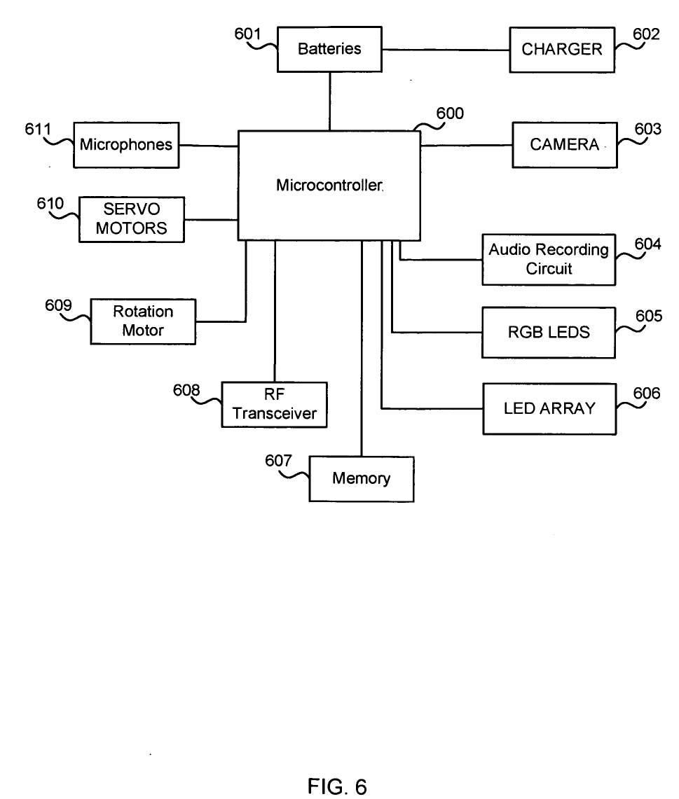

FIG. 6 is a schematic diagram of electronic components of the recall device. In this example only one microprocessor 600 is shown although it is also possible to use two or more microprocessors. Power is provided using batteries 601 which may be rechargeable using a charger 602. The microprocessor is arranged to control a camera 603 as well as an audio recording circuit 604, which may be integral with camera 603, for recording sound either using microphones 611 or using microphones integral with the camera 603. RGB LEDs 605 and an LED array 606 are also controlled by the microprocessor. A memory 607 is provided for storing captured data from the camera 603. A memory at the microprocessor may also be used to store microphone data, thresholds, criteria, rules, instructions and the like for use by the microprocessor 600. For example, the memory may be an SD card. In some embodiments the recall device incorporates a radio frequency transceiver 608 controlled by the microprocessor and suitable for receiving sensor data and for sending content captured by the camera and/or microphones to other entities. The microprocessor 600 also controls the rotation motor 609 and servo motors 610 to enable the pan and tilt of the device to be adjusted.

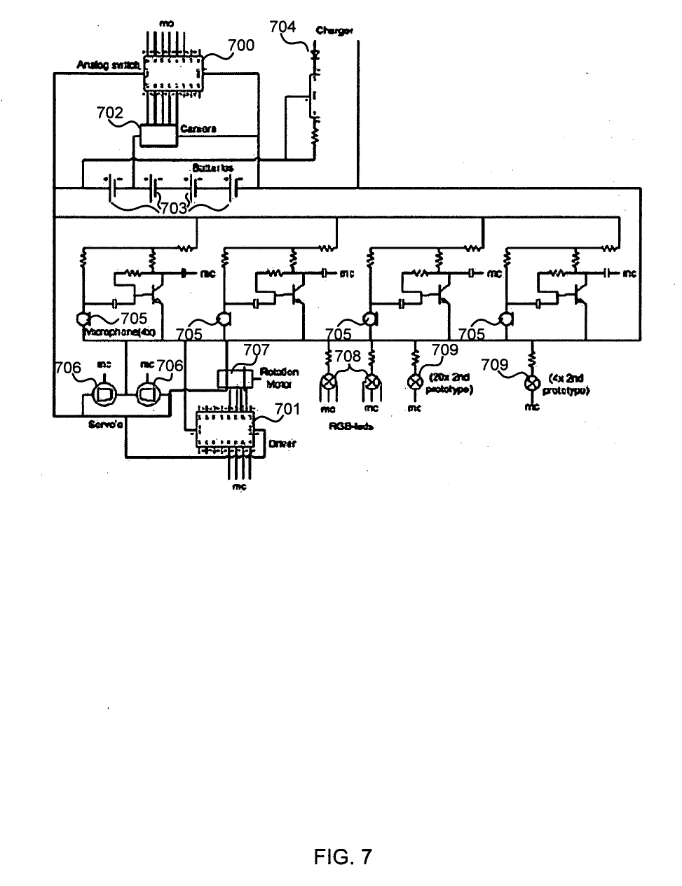

FIG. 7 is a schematic diagram of an example electronic circuit used within an embodiment of a recall device having four microphones. This shows a relay 700 which is controlled by a microprocessor and switches a camera 702 on and off. It also controls the camera auto-focus and capture. A driver 701 is shown which is controlled by the microprocessor and which switches the rotation motor. Lines from 701 and from 700 are shown in FIG. 7 towards the abbreviation “mc” which stands for microcontroller (or microprocessor). The microprocessor itself is not shown in FIG. 7 for clarity. Batteries 703 are provided which may be charged using charger 704. In this example, four microphones 705 are illustrated although it is also possible to use two microphones as mentioned above. Two servo motors 706 are used, one for changing the tilt of the device and one for opening and closing the cover. A rotation motor 707 is provided to enable the housing to pan the camera. RGB LEDs 708 and LEDs 709 for the array and other feedback are also present.

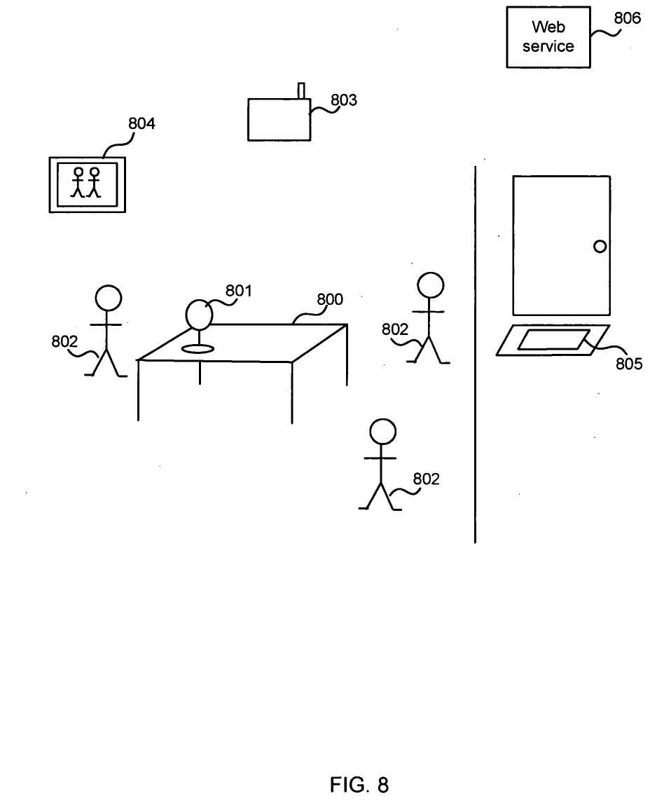

FIG. 8 is a schematic diagram of an environment in which the recall device is used. In this example the recall device 801 is shown standing on a table 800 in a room in which three people 802 are present. Attached to the wall of the room is a digital photo frame 804 and a wireless transceiver 803. Other sensors are embedded in the environment. For example, in an adjacent room a sensor 805 is placed under a doormat to sense when a person enters or leaves the building. Any other suitable types of sensor may be used. A web service 806 is represented schematically although infrastructure for supporting this web service may be located elsewhere. The recall device is able to receive sensor data from external sensors such as pressure sensor 805 via a wireless hub 803 communicating with a wireless transceiver in the recall device. This enables the behavior of the recall device to be influenced by external sensors embedded in the environment local to the device or embedded in environments at remote geographical locations.

As mentioned above, the recall device is arranged to capture any combination of audio, video and still images and optionally also sensor data. This captured content is then used to assist in recall of moments from the past by review or display of that content in any suitable manner. For example, this may be by using the web service 806, by using dedicated display devices such as digital photo frames 804, or by using any other suitable content retrieval and display equipment. The recall device is configured to project its own presence into a social environment. This is achieved through the use of attention devices incorporated into the recall device together with behavior programming that makes use of sensor data.

In the embodiment described above the attention devices comprise the RGB LEDs, the array of LEDs, the mechanical mechanisms used to pan and tilt the device and to open and close its cover. These mechanical mechanisms also produce sounds as a natural part of their occurrence. However, these are a non-exhaustive list of examples. Any other suitable attention devices may be used. For example, loudspeakers, other moving parts, other display devices.

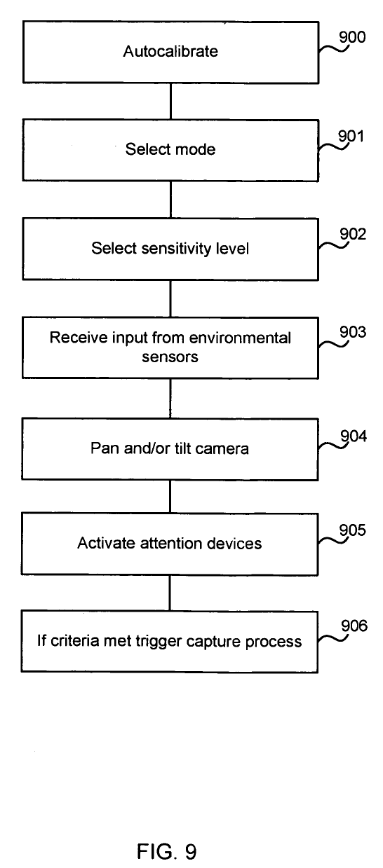

More information about the behavior programming is now given with reference to FIGS. 9 to 11. FIG. 9 is a flow diagram of a method at the recall device. An optional auto calibration step 900 comprises taking sensor readings for a specified period of time such as 10 minutes and determining an average sensor reading over that time period. Any future sensor reading deviating from this average by a specified amount or proportion is then used to trigger a capture process whereby the recall device captures content. However, this calibration step 900 is optional.

A user is able to select a capture mode 901, for example, using selection wheel 107. A user is also able to select a sensitivity level 902 for the sensors using slider 108. For example, for a children's party this may be set to low sensitivity but for a quiet two person conversation this may be set to high sensitivity. Input is received from the environmental sensors 903. For example, these may be the microphones of the embodiment of FIG. 1. These may also be sensors external to the device such as sensor 805 of FIG. 8. It is also possible to use other types of sensors in the device such as light sensors, temperature sensors, movement sensors, pressure sensors.

The camera is panned and/or tilted 904 in response to the sensor input received at step 903. For example, in the embodiment of FIG. 1 the device pans towards the microphone that receives the greatest signal. The attention devices are then optionally activated 905. For example, this may occur as a result of the panning step 904 itself because the action of panning the device creates a movement and sound which attracts attention. It is also possible for the RGB LEDs and or the LED array to be activated. If criteria are met the microprocessor then triggers a capture process 906. The criteria may be thresholds, rules, parameter ranges and the like stored at the device and pre-configured or set during an auto calibration process. For example, a decibel threshold may be used whereby if either of the microphones detects a decibel level above this threshold the capture process is initiated. In another example, the criteria comprises a rule whereby if nothing is sensed for a specified time period then the capture process is initiated. In other examples combinations of conditions from different sensors need to be met.

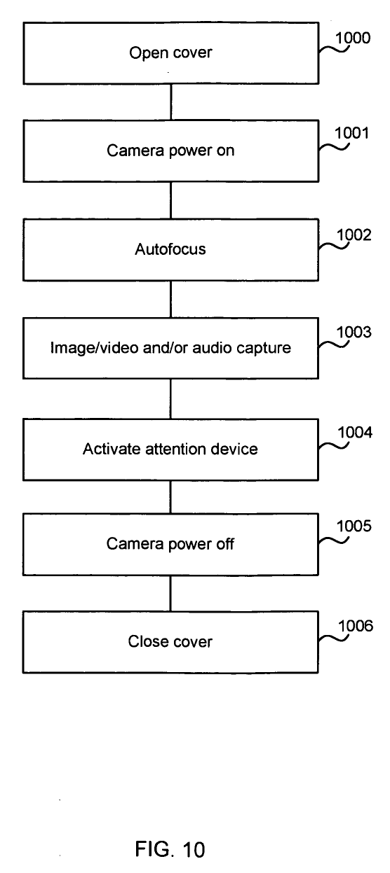

The capture process is now described with reference to FIG. 10. The microprocessor triggers opening 1000 of the cover and the camera is powered on 1001. The camera autofocus 1002 is initiated and capture 1003 begins. This may be video capture with audio, still image capture with audio, still image capture without audio or other capture modes. The capture mode is as selected by the user at step 901. During the capture process one or more attention device is optionally activated 1004. For example, the LED array is arranged to pulse or present a flow of lights along the array to indicate that capture is taking place. Once capture is complete the camera is powered off 1005 and the cover closed 1006.

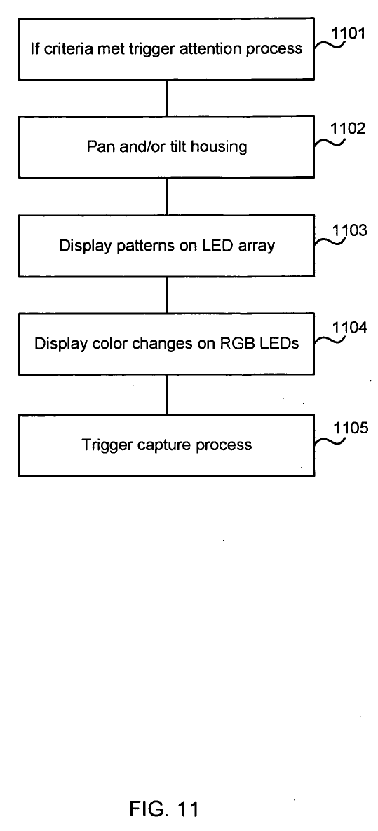

The attention process is now described with reference to FIG. 11. If specified criteria are met the attention process begins 1101. For example, if the recall device has not carried out the capture process for 30 minutes or another specified length of time then the attention process may be activated. The criteria may incorporate specified conditions of external sensors. For example, if a person is sensed entering a room in which the recall device is located, the attention process may be activated. The criteria are arranged in any suitable manner such that the recall device is perceived by human users as having its own “character” or “presence”.

The attention process comprises panning and/or tilting the housing 1102 using the servo motors as described. It optionally also comprises repeatedly opening and/or closing the cover or any combinations of panning, tilting, opening and closing. In addition, the attention process comprises displaying patterns of the LED array 1103. These patterns may be static in that various ones of the individual LEDs in the array are simply activated. The patterns may also be variable in that the individual LEDs in the array are controlled to produce waves or other moving patterns of light. The LEDs in the array may also be used to depict icons. For example, to provide user feedback whenever a different functionality is chosen using the selection wheel. The attention process also comprises displaying color 1104 using the RGB LEDs in a static manner or using color changes. The attention process optionally comprises triggering the capture process 1105. For example, if the recall device has been inactive for a specified time and it enters the attention process then it may be arranged to also enter the capture process at the end of the attention process. For example, the recall device attracts attention and then captures images and or audio information about its environment.

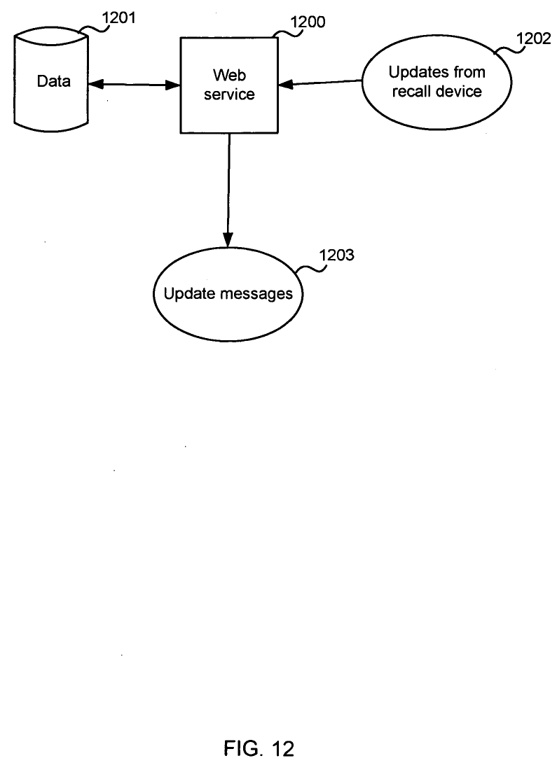

Once content has been captured by the recall device, this content may be accessed using a web service in some embodiments. For example, FIG. 12 illustrates such a web service 1200 arranged to receive updates from a recall device 1202. These updates comprise captured content such as video clips, still digital images with or without audio files and optionally also captured sensor data from external sensors and/or sensors integral with the recall device. The updates may also comprise metadata about the content such as a time and date at which the content was captured. The metadata may also comprise an identity of the recall device.

The updates are transferred from the recall device to the web service using a communications network of any suitable type. For example, this may be by using a wireless link between the recall device and a wireless hub which then transfers the updates to the web service using the Internet or other communications network. Once the web service 1200 receives the updates it stores the content and metadata at a database 1201 or other suitable storage device linked to the web service. The content and metadata is stored in a particular manner so that it may be retrieved in chronological order and is secure. Additional data about users who have registered the recall device with the web service may be stored.

The web service comprises rules and/or criteria to generate cues from the stored content and making use of the stored metadata. For example, the web service may comprises image analysis and/or audio analysis software to interpret the content and generate appropriate cues such as key words, sounds, thumbnail images, key phrases, and the like. The image analysis software may comprise object recognition software for identifying objects in images and classifying those objects into classes such as “animal”, “person”, “building”, “sky”, etc. An example of suitable object recognition software is, “J. Winn and N. Jojic, LOCUS: Learning Object Classes with Unsupervised Segmentation, Proc. IEEE Intl. Conf. on Computer Vision (ICCV), Beijing 2005” which is incorporated herein by reference in its entirety. The audio analysis software may comprise speech recognition software for recognizing words or phrases in audio files. These cues are generated and stored at the database 1201 in association with the captured content. The term “cue” is used to refer to a piece of information which at least partially identifies an item rather than uniquely identifying that item. Once the database 1201 has been updated with the generated cues update messages are generated by the web service 1203. These update messages are of any suitable type such as email, SMS message, voice mail message and the like. The update messages are sent to users registered with the web service and associated with the recall device concerned. The update messages inform the users that content has been received and is available for access.

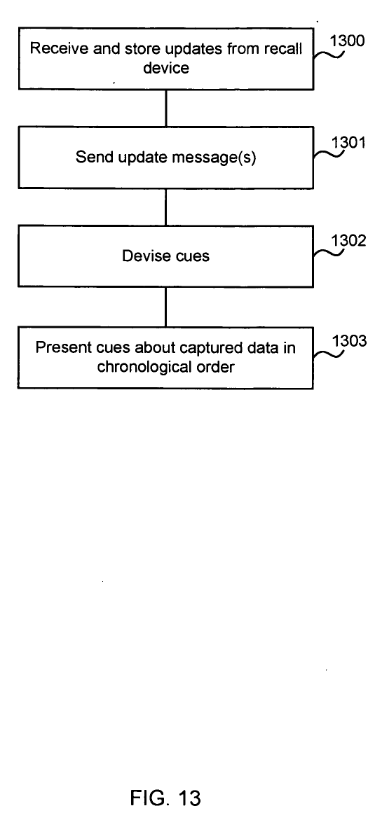

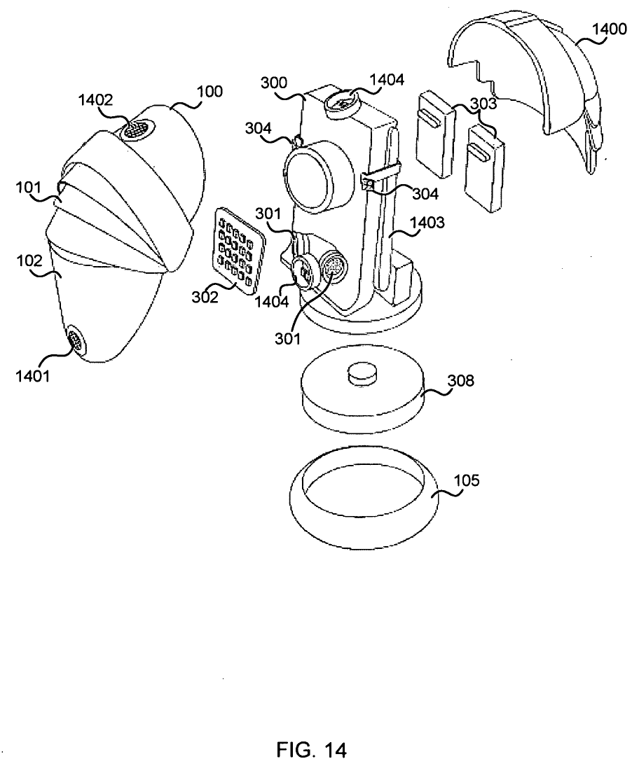

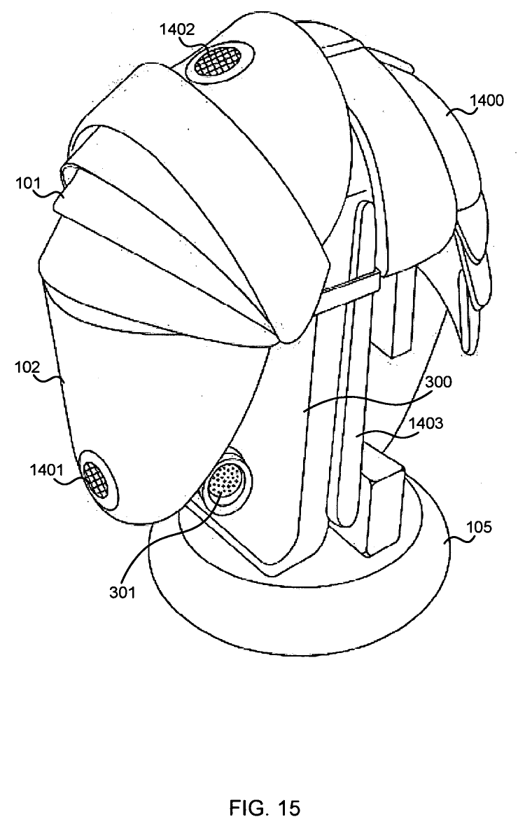

As explained with reference to FIG. 13 the web service 1200 receives and stores updates from a recall device 1300. The updates comprise captured content and metadata as well as information about the identity of the recall device. The web service generates 1302 and stores cues using the content and the metadata as well as any other information about users registered in association with the recall device. Update messages are then sent to the users 1301 to inform them that content is available. When a user accesses the web service and logs in he or she is able to view a content “map” display which presents the generated cues about the captured content in chronological order 1303. By selecting these cues the user is able to bring up a display of the full content. As content available to the web service grows the cues generated by the web service grows dynamically. In some embodiments the web service does not provide a live feed channel in that users cannot immediately access captured content but rather wait days or at least hours to retrieve this so that an element of surprise is introduced. However, this is not essential. Another embodiment of a recall device is now described with reference to FIG. 14 and FIG. 15. In this example, the recall device is again configured to stand on a surface and comprises a digital camera 300 mounted on a stand 1403 which is supported on a base 105. A stepping motor 308 is incorporated in the base 105 to enable the recall device to rotate autonomously. Mounted on the camera is a pair of microphones 301 laterally spaced apart and angled away from each other. The microphones protrude from an outer housing as illustrated in FIG. 15. Also mounted on the camera 300 is a pair of RGB LEDs 304 and two pressure sensors 1404.

An outer housing protects the camera 300 and that housing comprises a front cover 102 which is fixed, a retractable cover 101 and fixed upper cover 100 and back cover 1400. User operable buttons 1401 and 1402 are provided in the housing and arranged to be positioned over the pressure sensors 1404 mounted on the camera. An array of LEDs 302 and two microprocessors 303 are mounted in the recall device either on the housing or on the camera and stand 1403.

FIG. 15 shows the recall device in a closed configuration with the camera covered by the housing. When the recall device is in a capture process the retractable cover 101 opens to reveal the camera lens. Servo motors are incorporated in the recall device such that when the user presses buttons 1401 or 1402 the tilt of the camera is adjusted. For example, if button 1401 is pressed once the camera is tilted one step downwards towards the surface on which the recall device is standing. If this button is held down the camera continues to tilt downwards whilst the button is depressed. Operation of the button 1402 is similar to tilt the recall device in the opposite direction.

In another embodiment the buttons 1401 and 1402 are touch-pads each covering a microphone and a pair of feedback LEDs. That is, in some embodiments pressure sensors 1404 are each replaced by a microphone and a pair of LEDs. When a user taps a touch-pad 1401, 1402 the microphone below the touch-pad senses sound of the tap and this is used to trigger movement of the tilt of the device as described above for the pressure sensors 1404. The LEDs may be lit as part of the attention process mentioned above and/or to provide feedback about operation of the tilt mechanism.

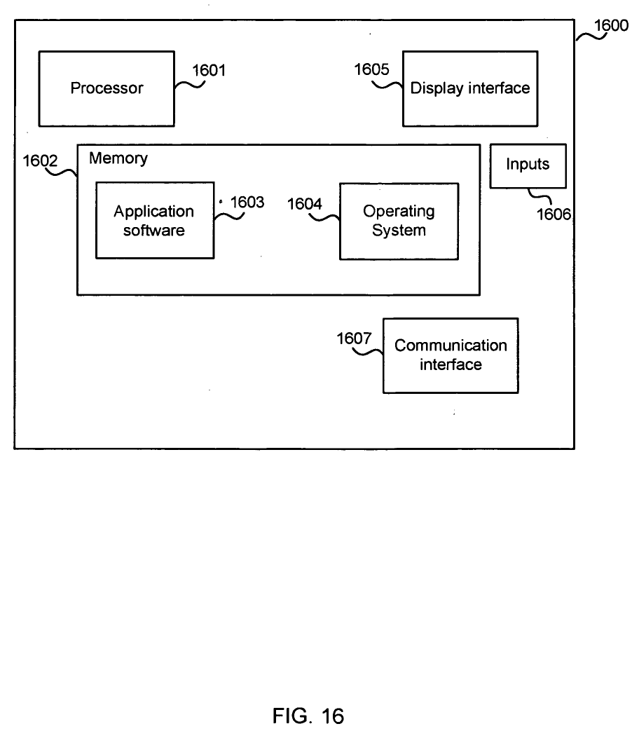

FIG. 16 illustrates various components of an exemplary computing-based device 1600 which may be implemented as any form of a computing and/or electronic device, and in which embodiments of a web service and/or a recall device may be implemented.

The computing-based device 1600 comprises one or more inputs 1606 which are of any suitable type for receiving media content, Internet Protocol (IP) input, email messages, sensor data, content files, digital images, audio files, user meta data, and other content. The device also comprises communication interface 1607 to enable the device to communicate with other entities over any suitable communications network such as the Internet, wireless communications interfaces and the like.

Computing-based device 1600 also comprises one or more processors 1601 which may be microprocessors, controllers or any other suitable type of processors for processing computing executable instructions to control the operation of the device in order to provide a recall device and/or a web service for provision of content captured using the recall device. Platform software comprising an operating system 1604 or any other suitable platform software may be provided at the computing-based device to enable application software 1603 to be executed on the device.

The computer executable instructions may be provided using any computer-readable media, such as memory 1602. The memory is of any suitable type such as random access memory (RAM), a disk storage device of any type such as a magnetic or optical storage device, a hard disk drive, or a CD, DVD or other disc drive. Flash memory, EPROM or EEPROM may also be used.

An output 1605 is also provided such as an audio and/or video output to a display system integral with or in communication with the computing-based device. The display system may provide a graphical user interface, or other user interface of any suitable type although this is not essential.

The term ‘computer’ is used herein to refer to any device with processing capability such that it can execute instructions. Those skilled in the art will realize that such processing capabilities are incorporated into many different devices and therefore the term ‘computer’ includes PCs, servers, mobile telephones, personal digital assistants and many other devices.

The methods described herein may be performed by software in machine readable form on a tangible storage medium. The software can be suitable for execution on a parallel processor or a serial processor such that the method steps may be carried out in any suitable order, or substantially simultaneously.

This acknowledges that software can be a valuable, separately tradable commodity. It is intended to encompass software, which runs on or controls “dumb” or standard hardware, to carry out the desired functions. It is also intended to encompass software which “describes” or defines the configuration of hardware, such as HDL (hardware description language) software, as is used for designing silicon chips, or for configuring universal programmable chips, to carry out desired functions.

Those skilled in the art will realize that storage devices utilized to store program instructions can be distributed across a network. For example, a remote computer may store an example of the process described as software. A local or terminal computer may access the remote computer and download a part or all of the software to run the program. Alternatively, the local computer may download pieces of the software as needed, or execute some software instructions at the local terminal and some at the remote computer (or computer network). Those skilled in the art will also realize that by utilizing conventional techniques known to those skilled in the art that all, or a portion of the software instructions may be carried out by a dedicated circuit, such as a DSP, programmable logic array, or the like.

Any range or device value given herein may be extended or altered without losing the effect sought, as will be apparent to the skilled person.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

The steps of the methods described herein may be carried out in any suitable order, or simultaneously where appropriate. Additionally, individual blocks may be deleted from any of the methods without departing from the spirit and scope of the subject matter described herein. Aspects of any of the examples described above may be combined with aspects of any of the other examples described to form further examples without losing the effect sought.

The term ‘comprising’ is used herein to mean including the method blocks or elements identified, but that such blocks or elements do not comprise an exclusive list and a method or apparatus may contain additional blocks or elements.

It will be understood that the above description of a preferred embodiment is given by way of example only and that various modifications may be made by those skilled in the art. The above specification, examples and data provide a complete description of the structure and use of exemplary embodiments of the invention. Although various embodiments of the invention have been described above with a certain degree of particularity, or with reference to one or more individual embodiments, those skilled in the art could make numerous alterations to the disclosed embodiments without departing from the spirit or scope of this invention.

1. An autonomous recall device configured to operate in an environment, the device comprising:
at least one processor;
a camera movably mounted in a housing;
at least one environmental sensor arranged to monitor conditions in the environment;
at least one attention device for getting the attention of entities in the environment;
wherein the at least one processor is arranged to control the movement and actuation of the camera according to conditions monitored by the sensor in order to capture one or more images; and
wherein the at least one processor is arranged to control the attention getting device according to specified criteria and without the need for user input.

2. A recall device as claimed in claim 1 which is configured to stand on a surface.

3. A recall device as claimed in claim 1 wherein the at least one processor is arranged to control the attention getting device according to specified criteria in order to provide a sense of presence in the environment.

4. A recall device as claimed in claim 1 which is a dedicated recall device.

5. A recall device as claimed in claim 1 wherein the at least one environmental sensor comprises a first microphone laterally spaced from a second microphone and wherein the processor is arranged to pan the camera according to sound detected at the microphones.

6. A recall device as claimed in claim 1 comprising at least one microphone and wherein the recall device is arranged to capture any of video with sound, images without sound and images with sound.

7. A recall device as claimed in claim 1 wherein the attention device comprises one or more light sources.

8. A recall device as claimed in claim 1 wherein the housing comprises a retractable cover configured to cover the camera when closed and to reveal the camera when opened and wherein the at least one processor is arranged to trigger a capture process according to conditions monitored by the sensor, that capture process comprising automatically opening the housing, actuating the camera, operating the attention device and closing the housing.

9. A recall device as claimed in claim 1 comprising a wireless transceiver and wherein the at least one environmental sensor is separate from the recall device and is arranged to communicate with the recall device using the wireless transceiver.

10. A recall device as claimed in claim 1 wherein the at least one processor is arranged to control the camera to capture one or more images in the event that no images have been captured for a specified period of time.

11. A recall device as claimed in claim 5 wherein the at least one processor is arranged to carry out an auto-calibration process by monitoring the microphones for a specified period of time.

12. An autonomous portable recall device configured to operate in an environment, the device comprising:
at least one processor;
a camera movably mounted in a housing;
a pair of microphones, laterally spaced apart and arranged to monitor sound conditions in the environment;
at least one attention device for getting the attention of entities in the environment;
wherein the at least one processor is arranged to pan the camera towards the microphone which monitors the loudest sound;
wherein the at least one processor is arranged to actuate the camera according to monitored sound conditions;
wherein the at least one processor is arranged to control the attention getting device according to specified criteria and without the need for user input.

13. A recall device as claimed in claim 12 wherein the at least one processor is also arranged to actuate the camera in the event that the camera has not been actuated for a specified period of time.

14. A recall device as claimed in claim 12 wherein the camera is movably mounted in the housing such that the tilt of the camera is adjustable automatically.

15. A recall device as claimed in claim 12 wherein the attention devices comprise an array of light emitting diodes.

16. A recall device as claimed in claim 12 wherein the attention devices comprise colored light emitting diodes.

17. A recall device as claimed in claim 12 wherein the attention devices comprise an automatically retractable cover incorporated as part of the housing and configured to cover and reveal the camera.

18. A method of retrieving content captured by a recall device comprising:
at a web server, receiving items of content captured by a recall device together with an identity of the recall device and metadata about the content;
storing the received items of content, identity and metadata at a memory associated with the web server;
automatically generating at least one cue for each item of content;
generating and sending a message to a user associated with the recall device to indicate that items of content have been received;
providing the generated cues for display at a web browser;
receiving user input selecting at least one cue and providing the associated item of content for display at the web browser.

19. A method as claimed in claim 18 wherein the cues comprise words.

20. A method as claimed in claim 18 wherein the generated cues are provided in chronological order according to capture time of the items of content.
